(19) United States
(12) Patent Application Publication
(10) Pub. No.: US 2004/0136708 A1
(43) Pub. Date: Jul. 15, 2004

(54) Transceiver configured to store failure analysis information

(76) Inventors: Kevin Reid Woolf, Salinas, CA (US); Peter H. Mahowald, Los Altos, CA (US); Angeline Rodriguez, Palo Alto, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/346,923

(22) Filed: Jan. 15, 2003

(51) Int. Cl. H04B 10/08

(52) U.S. Cl. 398/22; 398/135

(57) ABSTRACT

A transceiver that includes a transmitter, a controller, and a memory accessible by the controller where the controller is configured to receive failure analysis information from the transmitter and store the failure analysis information in the memory is provided.

### THE FIELD OF THE INVENTION

The present invention generally relates to transceivers and, more particularly, to a transceiver configured to store failure analysis information.

### BACKGROUND OF THE INVENTION

Electrical components of computer systems, such as optical transceivers, are typically tested by a manufacturer prior to being provided to an end user. The tests often include operational and/or functional tests to ensure that a component works properly and does not include any defects. If a component does have defects that are detected during the testing process, a manufacturer may be able to isolate and analyze the source of the defect to determine what caused the component to fail. The manufacturer may use the information obtained from the failing component to identify improvements or other defects in like components.

Occasionally, a defect or failure occurs after the component has been operated by an end user. In such a case, the manufacturer may attempt to isolate and analyze the source of defect of a failed component that has been returned by a customer. Unfortunately, the manufacturer may have little or no information regarding the environment in which the component was operating under when it failed. In addition, the manufacturer may have little or no information regarding the manufacturing history of the failed component. Both the information about the operating conditions and the manufacturing history of the failed unit may be useful to a manufacturer to improve the quality of future components.

It would be desirable for the transceiver to identify relevant information to store for failure analysis later.

### SUMMARY OF THE INVENTION

The present disclosure provides a transceiver that includes a transmitter, a controller, and a memory accessible by the controller where the controller is configured to receive failure analysis information from the transmitter and store the failure analysis information in the memory.

### BRIEF DESCRIPTION OF THE DRAWINGS

FIG. 1 is a block diagram illustrating an embodiment of a system that includes a transceiver configured to store failure analysis information.

FIG. 2 is a flow chart illustrating a first embodiment of a method for storing failure analysis information.

FIG. 3 is a flow chart illustrating a first embodiment of a method for providing failure analysis information.

FIG. 4 is a flow chart illustrating a second embodiment of a method for storing failure analysis information.

FIG. 5 is a flow chart illustrating a second embodiment of a method for providing failure analysis information.

FIG. 6 is a flow chart illustrating a third embodiment of a method for storing failure analysis information.

FIG. 7 is a flow chart illustrating an embodiment of a method for accessing failure analysis information.

FIG. 8 is a flow chart illustrating an embodiment of a method for providing failure analysis information.

FIG. 9 is a block diagram illustrating an alternative embodiment of a system that includes a transceiver configured to store failure analysis information.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

A transceiver configured to store failure analysis information is shown and described herein. The transceiver receives failure analysis information from either an internal component or an external host and stores the information in a memory located on the transceiver. The failure analysis information may be accessed from the transceiver using an external host. The information may be used to analyze failures associated with the transceiver.

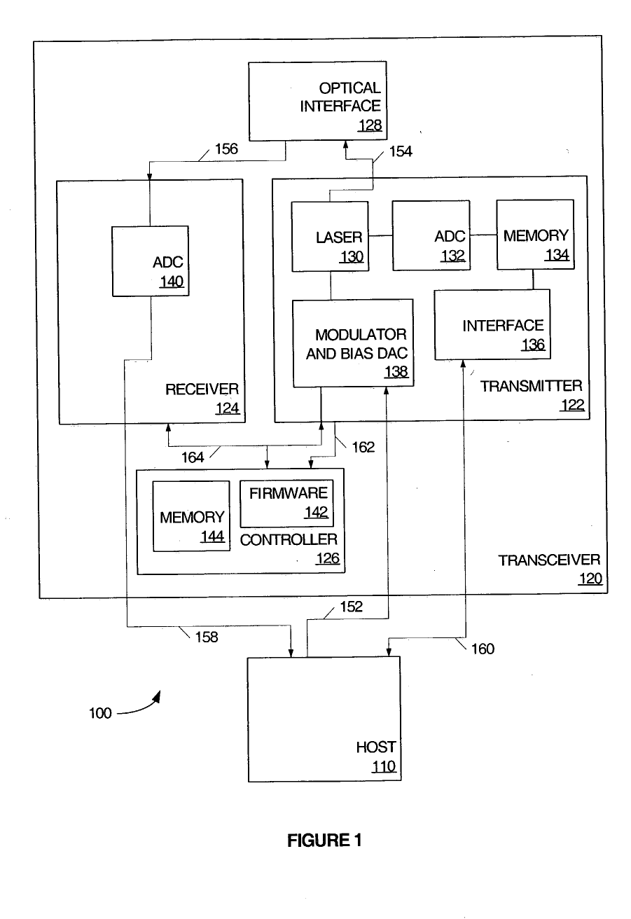

FIG. 1 is a block diagram illustrating an embodiment of a system 100 that includes a transceiver 120 configured to store failure analysis information. As shown, FIG. 1 includes a host 110 coupled to transceiver 120. Transceiver 120 includes a transmitter 122, a receiver 124, a controller 126, and an optical interface 128. Transmitter 122 includes a laser 130, an analog-to-digital converter (ADC) 132, a memory 134, an interface 136, and a modulator and bias digital-to-analog converter (DAC) 138. Receiver 124 includes an analog-to-digital converter (ADC) 140. Controller 126 includes firmware 142 and a memory 144.

Host 110 may be any type of wired or wireless device configured to operate in conjunction with transceiver 120. Host 110 is external to transceiver 120. Examples of such devices include a test system, a server computer system, a personal computer system, a laptop computer system, a handheld computer system, a personal digital assistant, and a mobile telephone.

Transceiver 120 comprises an optical transceiver configured to communicate with host 110 by sending and receiving electrical signals as described in additional detail herein below. Transceiver 120 also communicates with another device (not shown) by sending and receiving optical signals using optical interface 128. Optical interface 128 may be a Fibre Channel interface or another type of optical interface.

In one embodiment, transceiver 120 conforms to the SFF-8472 Specification for Digital Diagnostic Monitoring Interface for Optical Transceivers as set forth by the SFF (Small Form Factor) Committee. In other embodiments, transceiver 120 may conform to other specifications.

In operation, transmitter 122 comprises an optical transmitter configured to receive digital output signals from host 110 using a connection 152. Modulator and bias DAC 138 converts the digital output signals to analog output signals and provides the analog output signals to laser 130. The digital output signals and the analog output signals comprise electrical signals. Laser 130 generates optical output signals in response to the analog output signals and provides the optical output signals to optical interface 128 using a connection 154.

Receiver 124 comprises an optical receiver configured to receive optical input signals from optical interface 128 using a connection 156. Analog-to-digital converter 140 converts the optical input signals from analog input signals to digital input signals and provides the digital input signals to host 110 using a connection 158. The digital output signals and the analog output signals comprise electrical signals.

Transceiver 120 also communicates with host 110 using an electrical connection 160. In particular, transceiver 120 receives control signals from host 110 using connection 160. Transceiver 120 also provides information to host 110 using connection 160. In the embodiment of FIG. 1, electrical connection 160 couples host 110 to transmitter 122 and may be an I2C connection, as provided by the I2C-Bus Specification available from Philips Semiconductors at http://www.semiconductors.philips.com/acrobat/various/I2C_BUS_SPECIFICA TION_{—}3.pdf, or any other type of two-wire serial, serial or parallel connection. In embodiments where connection 160 comprises a two-wire serial connection such as an I2C connection, interface 136 comprises a two-wire serial bus interface. In other embodiments, electrical connection 160 may couple host 110 directly to controller 126 or other components of transceiver 120.

Controller 126 provides control signals to and receives feedback signals from transmitter 122 and receiver 124 using a connection 164. Connection 164 may be an internal I2C connection, as provided by the I2C-Bus Specification available from Philips Semiconductors at http://www.semiconductors.philips.com/acrobat/various/I2C_BUS_SPECIFICA TION_{—}3.pdf, or any other serial or parallel connection. Controller 126 includes firmware 142 that is executable by controller 126 to cause the control signals to be generated and the feedback signals to be received and processed. Memory 144 may be any type or combination of volatile and non-volatile storage including registers, EEPROM, flash memory, or RAM. In other embodiments, controller 126 may use other combinations of hardware and or software to perform the functions described herein.

Transceiver 120 is configured to store failure analysis information in memory 144. The failure analysis information may be stored periodically or in response to certain events such as errors or other failures. The failure analysis information may include manufacturing information and/or field operating condition information. Manufacturing information may include vendor identification information associated with one or more components of transceiver 120, date code information associated with one or more components of transceiver 120, and test information associated with one or more components of transceiver 120. Test information may include a name of a device used to test transceiver 120, a date of test, a product lot number, a serial number, and test results of tests performed on transceiver 120. Test results may include values associated with temperature, voltage, optical or other power, current, or other physical characteristics of transceiver 120. These values may be minimum, maximum, average, or other types of values for each physical characteristic. Field operating condition information may include any information generated or stored by transceiver 120 during operation of transceiver 120. Examples of such information include values that indicate temperature, power, voltage, current, or other physical characteristics of components of transceiver 120. These values may be minimum, maximum, average, transient, or other types of values for each physical characteristic. Other examples of field operating condition information include settings or configurations of transceiver 120 selected by a user.

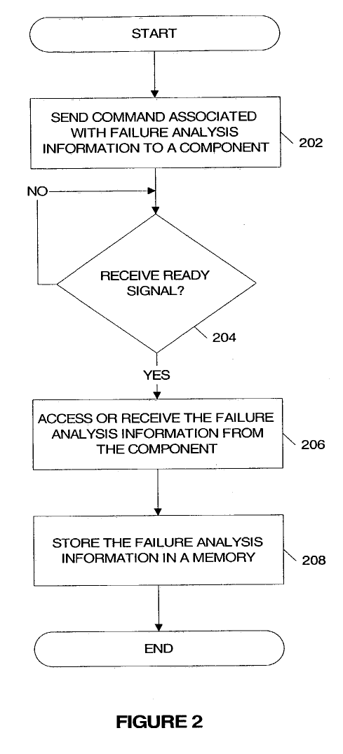

Controller 126 is configured to cause the failure analysis information to be stored in memory 144. As described in additional detail herein below with reference to FIGS. 2-8, controller 126 may access or receive failure analysis information from one or more components on transceiver 120 such as transmitter 122 and receiver 124, may cause a component on transceiver 120 to generate failure analysis information, may itself generate failure analysis information, and may receive failure analysis information from host 110. Controller 126 may be configured to cause the failure analysis information to be stored periodically during operation or in response to events such as configuration changes, errors, components failures, or power ups or power downs of transceiver 120. Controller 126 may be configured to store failure analysis information specific to a particular event.

FIG. 2 is a flow chart illustrating an embodiment of a method for storing failure analysis information where a controller accesses or receives failure analysis information from a component of a transceiver. The embodiment of the method of FIG. 2 will be described with reference to FIG. 1. In FIG. 2, a command associated with failure analysis information is sent by controller 126 to a component of transceiver 120 as indicated in a block 202. Components of transceiver 120 include transmitter 122, receiver 124, and any other part of transceiver 120 not shown in FIG. 1. A determination is made as to whether a ready signal has been received by controller 126 as indicated in a block 204. If the ready signal has not been received, then controller 126 repeats the function of block 204 at a later time. If the ready signal has been received, then the failure analysis information is accessed or received from the component by controller 126 as indicated in a block 206. The failure analysis information is stored in a memory as indicated in a block 208.

Controller 126 may be programmed to store only selected failure analysis information in block 208. For example, controller 126 may opt to store failure analysis information values that are different from expected values such as values that are outside of a minimum or maximum value threshold. In addition, controller 126 may opt to store failure analysis information associated with a configuration change of transceiver 120 by an user or associated with a fault or error condition of transceiver 120.

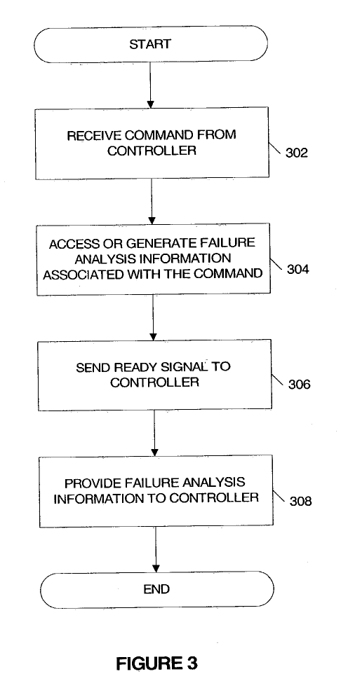

FIG. 3 is a flow chart illustrating an embodiment of a method for providing failure analysis information by a component of a transceiver. The embodiment of the method of FIG. 3 will be described with reference to FIGS. 1 and 2. In FIG. 3, a command is received from controller 126, such as the command generated in block 202, as indicated in a block 302. Failure analysis information associated with the command is accessed or generated as indicated in a block 304. In particular, the component may access the failure analysis information that is already present in the component, such as information stored in a register, or the component may generate the failure analysis information by causing a portion of the component to capture, create or calculate the information.

In response to the failure analysis information being accessed or generated by the component, a ready signal is sent from the component to controller 126 as indicated in a block 306 and is received by controller 126 as indicated in block 204. The ready signal may be an interrupt signal sent to controller 126 using connection 162, a flag that is polled by controller 126, or any other suitable signal to cause controller 126 to detect that the failure analysis information is available. The failure analysis information is provided to controller 126 as indicated in a block 308. The component may transmit the failure analysis information to controller 126 or store the information in a location accessible to controller 126. For example, where the component is transmitter 122, transmitter 122 may store the information in memory 134 and controller 126 may access the information from memory 134. Receiver 124 or other components of transceiver 120 may also include a memory accessible by controller 126 (not shown) for providing failure analysis information to controller 126.

Using the methods illustrated in FIGS. 2 and 3, transmitter 122 may store or generate failure analysis information to be provided to controller 126 for storage in memory 134. For example, light output power (LOP), optical modulation amplitude (OMA), average laser power, slope efficiency (the change in laser power divided by the change in laser current), threshold current, average laser bias current, other bias information, or other temperature, power, voltage, or current values of laser 130 may be detected by analog-to-digital converter 132 and stored in digital form in memory 134. Other information stored or generated by transmitter 122 may include transmission rate, error, clock frequency, Vcc, or bandwidth information. Controller 126 accesses or receives the failure analysis information as described above and stores the information in memory 144.

Receiver 124 may also store or generate failure analysis information to be provided to controller 126 for storage in memory 134 using the methods illustrated in FIGS. 2 and 3. For example, transmission rate, error, receiver sensitivity, loss of signal (LOS) threshold, LOS polarity, OMA, bandwidth, clock frequency, Vcc, or other temperature, power, voltage, or current values of receiver 124 may be detected or generated and either stored in a memory (not shown) for access by controller 126 or transmitted to controller 126.

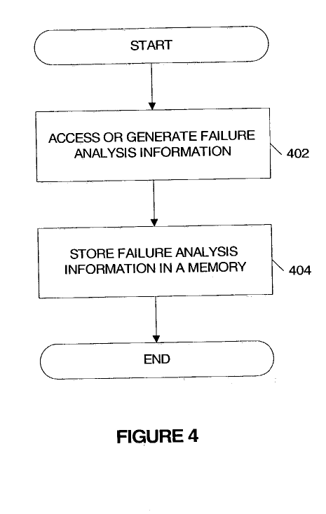

FIG. 4 is a flow chart illustrating an embodiment of a method for storing failure analysis information where a controller accesses or generates the information directly. The embodiment of the method of FIG. 4 will be described with reference to FIG. 1. In FIG. 4, failure analysis information is accessed or generated by controller 126 as indicated in a block 402. Controller 126 may access the information from any location in transceiver 120 accessible by controller 126 including a location within controller 126 itself. Additionally, controller 126 may generate the failure analysis information by processing information accessible by controller 126. Examples of information accessed or generated by controller information include an amount of run time of transceiver 120, state information of controller 126, and errors detected including bus collisions, corrupted registers, state mismatches between components of transceiver 120, and missed interrupt signals. The failure analysis information is stored in memory 144 as indicated in a block 404.

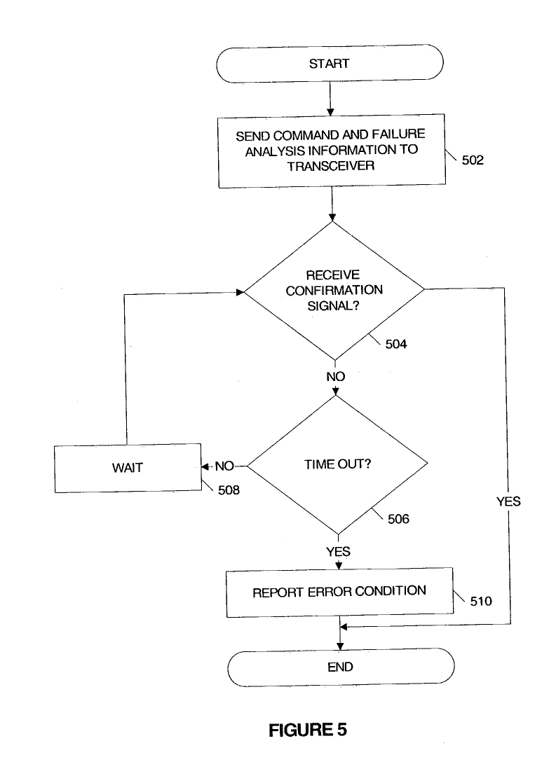

FIG. 5 is a flow chart illustrating an embodiment of a method for generating failure analysis information where an external host generates the information. The embodiment of the method of FIG. 5 will be described with reference to FIG. 1. In FIG. 5, a command and failure analysis information is sent by host 110 to transceiver 120 as indicated in a block 502. The command and failure analysis information may be received by interface 136 and stored in memory 134. Interface 136 may cause an interrupt to be sent to controller 126 using connection 162, a flag to be set for controller 126 to poll, or another notification signal to be provided to controller 126 in response to receiving the command and failure analysis information. A determination is made by host 110 as to whether a confirmation signal has been received from transceiver 120 as indicated in a block 504. The confirmation signal is generated by controller 126 and provided to host 110 by interface 136. If the confirmation signal has been received, then host 110 assumes that the failure analysis information was stored at a location associated with an address included with the command and the method completes. If the confirmation signal has not been received, then a determination is made by host 110 as to whether a time out condition has been reached as indicated in a block 506. If a time out condition has not been reached, then a wait state is assumed as indicated in a block 508 and the function of block 504 is repeated at a later time. If a time out condition has been reached, then an error condition is reported as indicated in a block 510 and the method completes.

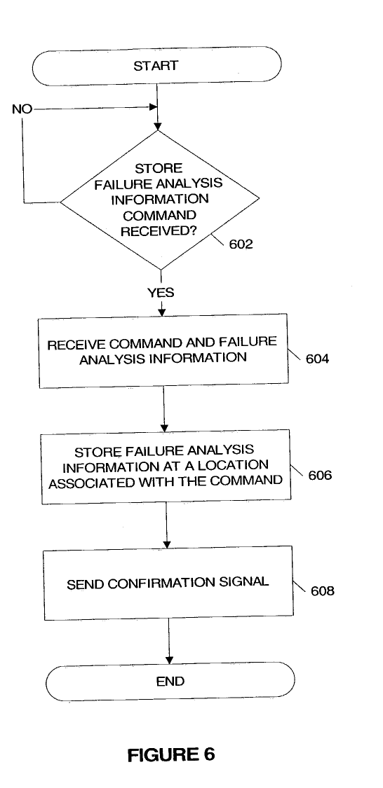

FIG. 6 is a flow chart illustrating an embodiment of a method for storing failure analysis information received from an external host. The embodiment of the method of FIG. 6 will be described with reference to FIGS. 1 and 5. In FIG. 6, a determination is made by controller 126 as to whether a store failure analysis information command has been received from host 110 as indicated in a block 602. If a store failure analysis information command has not been received, then the function of block 602 is repeated at a later time.

If a store failure analysis information command has been received, then the command and failure analysis information, as provided in block 502, are received by controller 126 as indicated in a block 604. Controller 126 causes the command and failure analysis information to be accessed from memory 134 in response to a signal from interface 136. Controller 126 processes the command to cause the failure analysis information to be stored at a location associated with an address included with the command as indicated in a block 606. A confirmation signal is sent by controller 126 as indicated in a block 608 and is received as indicated in block 504.

Using the method illustrated in FIGS. 5 and 6, host 110 causes failure analysis information to be stored on transceiver 120. Examples of such failure analysis information include manufacturing information such as vendor identification information associated with one or more components of transceiver 120, date code information associated with one or more components of transceiver 120, revision information associated with one or more components of transceiver 120, and test information associated with one or more components of transceiver 120. Test information may include a name of a device used to test transceiver 120, a date of test, a product lot number, a serial number, and test results of tests performed on transceiver 120. Test results may include values associated with temperature, voltage, power, current, or other physical characteristics of transceiver 120. In particular, test results may include a set of parameters generated by a test of transceiver 120 prior to transceiver 120 being provided to an end user of transceiver 120. During failure analysis of transceiver 120, host 110 may compare this set of test parameters to a set of parameters stored during operation of transceiver 120 using the methods illustrated by FIGS. 2, 3, and 4 and described above.

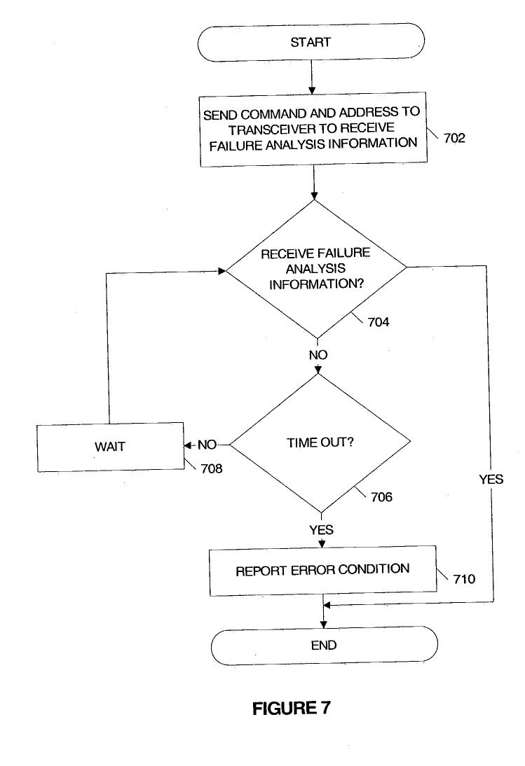

FIG. 7 is a flow chart illustrating an embodiment of a method for accessing failure analysis information from a transceiver by an external host. The embodiment of the method of FIG. 7 will be described with reference to FIG. 1. In FIG. 7, a command and address are sent by host 110 to transceiver 120 to cause failure analysis information to be received as indicated in a block 702. The command and address may be received by interface 136 and stored in memory 134. Interface 136 may cause an interrupt to be sent to controller 126 using connection 162, a flag to be set for controller 126 to poll, or another notification signal to be provided to controller 126 in response to receiving the command and failure analysis information. A determination is made as to whether the failure analysis information has been received as indicated in a block 704. If the failure analysis information has been received, then the method completes.

If the failure analysis information has not been received, then a determination is made as to whether a time out condition has been reached as indicated in a block 706. If a time out condition has not been reached, then a wait state is assumed as indicated in a block 708 and the function of block 704 is repeated at a later time. If a time out condition has been reached, then an error condition is reported as indicated in a block 710 and the method completes.

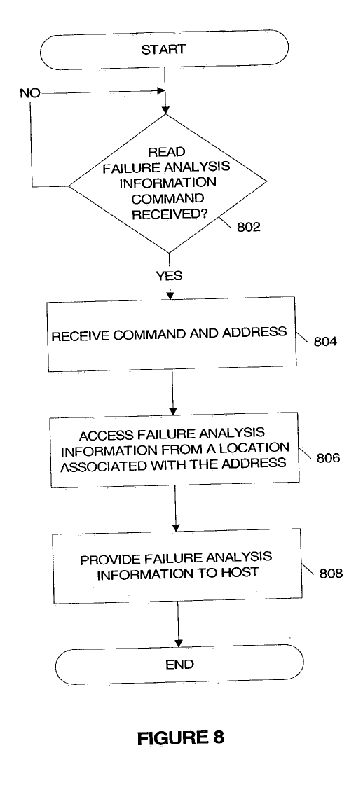

FIG. 8 is a flow chart illustrating an embodiment of a method for providing failure analysis information from a transceiver to an external host. The embodiment of the method of FIG. 8 will be described with reference to FIGS. 1 and 7. In FIG. 8, a determination is made as to whether a read failure analysis information command has been received by transceiver 120 as indicated in a block 802. If a read failure analysis information command has not been received, then the method repeats the function of block 802 at a later time.

If a read failure analysis information command has been received, then the command and address are received as indicated in a block 804. The read failure analysis command is received from host 110 using interface 136 and stored in memory 134. Controller 126 causes the command and address to be accessed from memory 134 in response to a signal from interface 136. Controller 126 processes the command to cause failure analysis information associated with the address to be accessed from a location associated with the address as indicated in a block 806. Controller 126 causes the failure analysis information to be provided to transmitter 122 which stores the information in memory 134. The failure analysis information is provided from memory 134 to host 110 using interface 136 as indicated in a block 808.

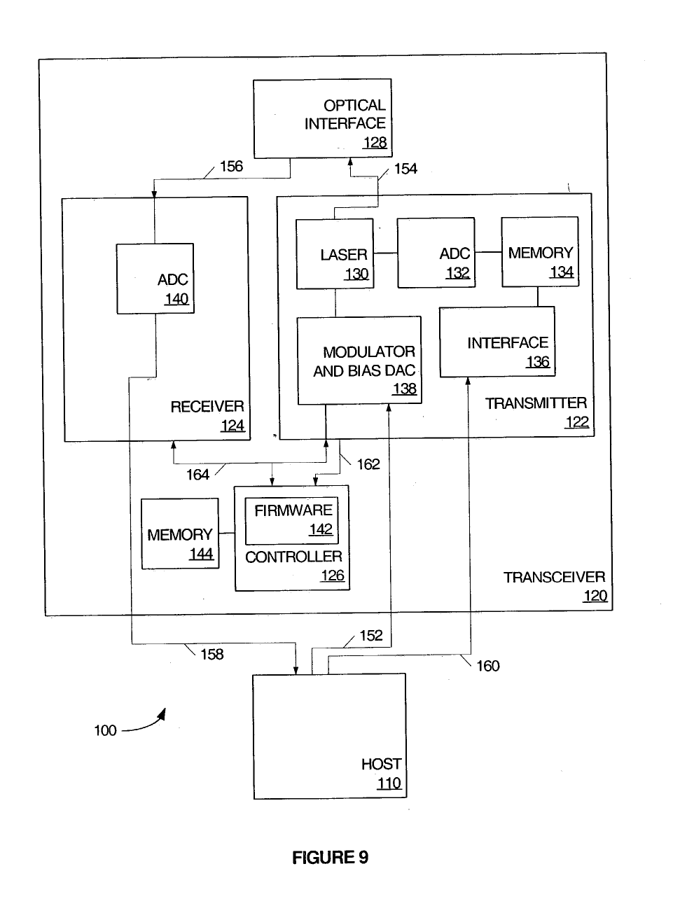

FIG. 9 is a block diagram illustrating an alternative embodiment of system 100 that includes transceiver 120 configured to store failure analysis information. The embodiment of FIG. 9 operates in substantially the same way as the embodiment of FIG. 1 described above. In FIG. 9, however, memory 144 is not included in controller 126. This embodiment illustrates that memory 144 may be included in any other portion or component transceiver 120.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A transceiver comprising:
a transmitter;
a controller coupled to the transmitter; and
a memory accessible by the controller;
wherein the controller is configured to receive first failure analysis information from the transmitter, and wherein the controller is configured to store the first failure analysis information in the memory.

2. The transceiver of claim 1 further comprising:
a receiver;
wherein the controller is configured to receive second failure analysis information from the receiver, and wherein the controller is configured to store the second failure analysis information in the memory.

3. The transceiver of claim 1 wherein the transmitter is configured to receive the first failure analysis information from an external host.

4. The transceiver of claim 3 wherein the transmitter is configured to provide a signal associated with the first failure analysis information to the controller in response to receiving the first failure analysis information from the external host.

5. The transceiver of claim 1 wherein the transmitter is configured to provide the first failure analysis information to the controller in response to a command received from the controller.

6. The transceiver of claim 5 wherein the transmitter is configured to generate the first failure analysis information in response to the command.

7. The transceiver of claim 5 wherein the transmitter is configured to access the first failure information from a register in response to the command.

8. The transceiver of claim 1 wherein the transceiver comprises an optical transceiver.

9. The transceiver of claim 1 wherein the controller includes the memory.

10. The transceiver of claim 1 wherein the first failure analysis information includes temperature information.

11. The transceiver of claim 1 wherein the first failure analysis information includes optical power information.

12. The transceiver of claim 1 wherein the first failure analysis information includes manufacturing information.

13. The transceiver of claim 1 wherein the first failure analysis information includes test information.

14. A system comprising:
a host; and
a transceiver coupled to the host, the transceiver configured to store failure analysis information;
wherein the host is configured to access the failure analysis information.

15. The system of claim 14 wherein the transceiver includes a controller configured to cause the failure analysis information to be stored during operation of the transceiver.

16. The system of claim 15 wherein the controller is configured to cause the failure analysis information to be stored in response to detecting an error.

17. The system of claim 14 wherein the transceiver includes a laser, and wherein the failure analysis information is associated with the laser.

18. The system of claim 17 wherein the failure analysis information includes power information associated with the laser.

19. The system of claim 14 wherein the transceiver includes an optical receiver, and wherein the failure analysis information is associated with the optical receiver.

20. The system of claim 14 wherein the failure analysis information includes temperature information.

21. The system of claim 14 wherein the failure analysis information includes a first set of parameters generated in response to testing the transceiver and a second set of parameters generating during operation of the transceiver, and wherein the host is configured to compare the first set of parameters to the second set of parameters.

22. A transceiver comprising:
a controller; and
a memory accessible by the controller;
wherein the controller is configured to receive failure analysis information from an external host, and wherein the controller is configured to cause the failure analysis information to be stored in the memory.

23. The transceiver of claim 22 wherein the failure analysis information includes test information generated in response to testing the transceiver.

24. The transceiver of claim 22 wherein the failure analysis information includes manufacturing information associated with a component of the transceiver.

25. The transceiver of claim 22 wherein the controller is configured to cause the failure analysis information to be provided to the external host in response to receiving a request from the external host.

26. The transceiver of claim 22 further comprising:
a laser configured to generate optical output signals.

27. The transceiver of claim 22 further comprising:
a two-wire serial bus interface configured to receive the failure analysis information from the external host.

28. The transceiver of claim 27 further comprising:
a transmitter that includes the two-wire serialbus interface.

29. A transceiver comprising:
first means for storing failure analysis information;
second means for receiving the failure analysis information and for causing the failure analysis information to be stored; and
third means for providing the failure analysis information to the second means.

30. The transceiver of claim 29 wherein the third means comprises a transmitter.

31. The transceiver of claim 29 wherein the third means comprises a receiver.

32. The transceiver of claim 29 wherein the third means is for receiving the failure analysis information from an external host.

33. The transceiver of claim 29 wherein the third means is for accessing the failure analysis information.

34. The transceiver of claim 29 wherein the third means is for generating the failure analysis information.

35. The transceiver of claim 29 further comprising:
a laser configured to receive electrical signals from an external host and configured to generate optical signals in response to the electrical signals.
